(19) United States
(12) Patent Application Publication
(10) Pub. No.: US 2002/0055343 A1
(43) Pub. Date: May 9, 2002

(54) Apparatus and method for radio program guide capability in a digital radio system

(76) Inventors: Trudy D. Stetzler, Houston, TX (US); Naresh Coppisetti, Sugar Land, TX (US); Burc A. Simsek, Houston, TX (US)

Correspondence Address: TEXAS INSTRUMENTS INCORPORATED, P O BOX 655474, M/S 3999, DALLAS, TX, 75265

(21) Appl. No.: 09/802,732

(22) Filed: Mar. 9, 2001

Related U.S. Application Data
(60) Provisional application No. 60/188,696, filed on Mar. 13, 2000.
(60) Provisional application No. 60/253,523, filed on Nov. 28, 2000.

(51) Int. Cl. H04H 1/00

(52) U.S. Cl. 455/260; 455/3.02; 455/45

(57) ABSTRACT

In a digital radio receiver, at least one receiver train demodulates signal from a transmitter to which the receiver is tuned. The signal includes two data streams, typically a program stream and an information stream. The processor separates the two data streams and typically applies the program data stream to an output unit such as a speaker. The processor analyses the information stream and, when appropriate, stores the information stream. The information stream can be used to provide program information or information of importance to the user. A second receiver train can be used by the radio to scan the signals from other transmitters. The information from the other transmitters can be used to identify possible alternatives to the present programming or to automatically apply different program material to the speaker.

This application claims priority under 35 USC § 119(e)(1) of provisional application No. 60/188,696, filed Mar. 13, 2000, and provisional application No. 60/253,523 filed Nov. 28, 2000.

### RELATED APPLICATIONS

U.S. patent application Ser. No. ______ (Attorney Docket Number TI-30649): APPARATUS AND METHOD FOR GLOBAL DIGTAL RADIO, invented by Trudy D. Stetzler, Burc A. Simsek, Robert G. DeMoor, Naresh Coppisetti, John H. Gardner, Gene A. Frantz, Carol Ann Levasseur, Aamer Salahuddin, Keith G. Gutierrez, Philip S. Stetson, and Douglas S. Rasor, filed on even date herewith and assigned to the assignee of the present application, is a related application; and,

U.S. patent application Ser. No. ______ (Attorney Docket Number TI-30668): APPARATUS AND METHOD FOR TRANSPARENT UPGRADING OF TECHNOLOGY AND APPLICATIONS IN DIGITAL RADIO USING PROGRAMMABLE TRANSMITTERS AND RECEIVERS, invented by Trudy D. Stetzler and Burc A. Simsek, filed on even date herewith and assigned to the assignee of the present application, is a related application.

### BACKGROUND OF THE INVENTION 1. Field of the Invention

This invention relates generally to communication apparatus and, more particularly, to digital radio transmitters and receivers. The inclusion of a processor in a digital radio permits functions to be added to the system that would not otherwise be available. One of the added functions is the ability to search automatically for stations or program material identified by preselected criteria.

2. Background of the Invention

When a user becomes dissatisfied with the program content of the station to which his radio receiver is tuned, the typical procedure has been, when one is unfamiliar with the available program content, to tune manually the radio receiver until a station with sufficient strength to provide intelligible audio output is acquired. The user would then leave the tuner on that station until a determination was made whether the program content was acceptable.

Most automobile radios currently on the market in the U.S. have a seek feature. By pressing the appropriate control button, the next station, in either descending or ascending frequency order, with sufficient signal strength, is acquired by the radio receiver and played over the speaker system. The user can listen for a few moments and, if the program material is not satisfactory, the user can acquire another station by pressing the seek button. The process can be continued until a suitable station is found, at which point the user can discontinue this search. As will be clear, the necessity for continually pushing a button, while driving, can be distracting. In addition, program sampling in this manner can provide atypical material, or at least a misleading program sample. Thus, the user may skip over an acceptable station or may stay tuned to an unacceptable station until the true nature of the broadcast material becomes clear.

In addition, some automobile radios have a sample feature. The scanning tuner will systematically scan the broadcast spectrum. When a signal with sufficient strength is detected, the scanning will stop, and the acquired station will be played for a predetermined period of time. When a station with acceptable program content is acquired, the user can stop the tuner from further scanning and remain tuned to this station. This procedure has the advantage for automobile radios in that little involvement by the user is required. However, the procedure suffers from the problem that all stations, even stations with clearly unacceptable content, are sampled. In addition, the sampling of a station may take place during presentation of atypical material. Finally, in a large urban environment, a sampling of all of the available stations may be time consuming and can cause the user/driver to lose focus on the operation of the vehicle.

A need has therefore been felt for apparatus and an associated method having the feature that the selection of a radio station can be based on more selective criteria than a sample of all of the presently playing program material. It would be a further feature of the apparatus and associated method to provide some level of detail concerning the program schedule of each station. It would be a more specific feature of the present apparatus and associated method to provide a station selection procedure that would require relatively little input from a user/automobile operator. It is yet another specific feature of the apparatus and associated method that the selection process can respond to oral commands. It is yet a further feature of the present invention that the radio receiver is able to receive and select signals from broadcast stations that provide a characterization of the program content. It is yet another feature of the apparatus and associated method that the radio receiver can automatically select and/or prioritize program material for presentation to the user. It is a still further feature of the present invention to provide apparatus and an associated method for permitting a user to select specialty program content. It is yet a still further feature of the present invention to provide a return path to the radio transmitter so that a user can interact with the program content.

### SUMMARY OF THE INVENTION

The aforementioned and other features can be accomplished, according to the present invention, by providing the radio receiver with a processor for controlling analyzing signals applied to the radio receiver and for controlling the flow of signals in the radio receiver. The processor can determine which signals to store in a storage unit and which to apply to the speaker and/or output unit. The program information received by the radio receiver can take the form of the program material, a characterization of the type of material broadcast by each station, or a schedule of the program material to be broadcast at a later date. The digital radio transmitter can broadcast two information streams over the same broadcast channel, e.g., program material and information material. The radio receiver unit can utilize one receiver train to demodulate both sets of signals and the processor can separate the program material from the information material. When information material contains program information for transmitter to which the radio receiver is tuned as well as information material for nearby transmitters, then only one receiver train is necessary. The program schedule and the type of broadcast material can be made available to the radio receiver using two additional techniques. However, using either of these techniques requires that the radio receiver unit have two receiver chains or a wideband receiver capable of receiving all of the transmissions in the entire broadcast band. In the first technique, a selected transmitting station provides the program information concerning all of the stations in the region either on the program material signal stream or on the information material signal stream of the transmitter. In the second technique, program schedule information is provided as part of the information signal stream from each transmitting station. The program schedule can be provided with various levels of detail. Furthermore, the information material signal stream can include a characterization of the program material. The two receiver trains in the radio receiver permit the reception of program material from one transmitting unit and the reception of program material characterization and program schedule material from the other transmitting units. The processor can control the systematic sampling of all of the transmitting units and controls the storage of the program material characterization and program schedule material in the storage unit. The processor also controls the retrieval of the program characterization material by the user/driver of the radio receiver and can provide the retrieved material in a format for easy accessibility by the user. When the user preferences are known and sufficient information for each program unit (e.g., song) is provided on the program schedule signal stream, the radio receiver unit, under control of the processor, can automatically accommodate the preferences of the user without the user's intervention.

### BRIEF DESCRIPTION OF THE DRAWINGS

FIG. 1 is a block diagram of a first embodiment of a digital radio receiver according to the present invention.

FIG. 2 is a block diagram of a second embodiment of a digital radio receiver according to the present invention.

FIG. 3 is a flow chart of the operation of the second receiver train of the digital radio receiver according to the present invention.

FIG. 4 illustrates the structure of the files stored in the storage unit of the digital radio receiver according to the present invention.

FIG. 5A and FIG. 5B illustrate two radio broadcast transmitter environments for which operation of the present invention is intended.

FIG. 6A and FIG. 6B illustrate two display modes of user display for use with a digital radio receiver according to the present invention, while

FIG. 6C illustrates display elements for a complex display.

FIG. 7A illustrates digital radio system having a simple receiver unit, while

FIG. 7B illustrates a complex receiver unit.

### DESCRIPTION OF THE PREFERRED EMBODIMENTS

1 Detailed Description of the Figures

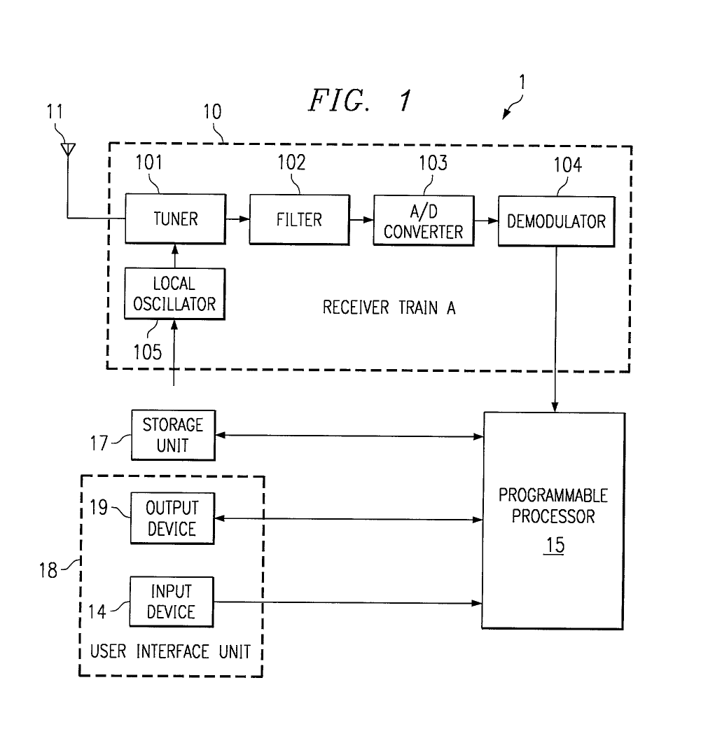

Referring to FIG. 1, a radio receiver unit 1, according to a first embodiment of the invention, is shown. An antenna 11 provides radio signals from transmitters to the tuner 101 of receiver train A 10. The tuner 101 also has signal applied from a local oscillator 105 applied thereto. The tuner 101 can include a low noise amplifier, not shown and a mixer, not shown. An output signal from the tuner 101 is applied to filter 102. The output signal from filter 102 is applied to A/D (analog to digital) converter 103. The output signal from A/D converter 103 is applied to demodulator 104 and the output signal from the demodulator 104, which signal is the output signal from receiver train A 10 is applied to the programmable processor 15. The programmable processor exchanges signals with a storage unit 17. Storage unit 17 can be implemented with a RAM memory, a flash memory unit, or any storage unit that is compatible with the programmable processor 15 and compatible with the application for which the receiver was intended. The programmable processor applies signals to and receives signals from user interface unit 18. The user interface unit 18 includes an output device 19, such as a speaker system and/or a display unit, etc., and an input device 14. The programmable processor 15 receives input from the user by means of the input device 14. In this manner, the user is able to control the operation of the receiver 1. The input device 14 can include a voice-activated device, a keypad, interactive screen, smart card, compact flash card, a Bluetooth device, etc. or any other device that permits the user to provide control signals to the radio receiver 1. The principal requirement of the input device 14, particularly as it relates to an automobile radio receiver, is that the interaction between the user and the interface unit provide as little distraction as possible from the operation of the motor vehicle. This limitation is not relevant to receiver units in non-automotive applications

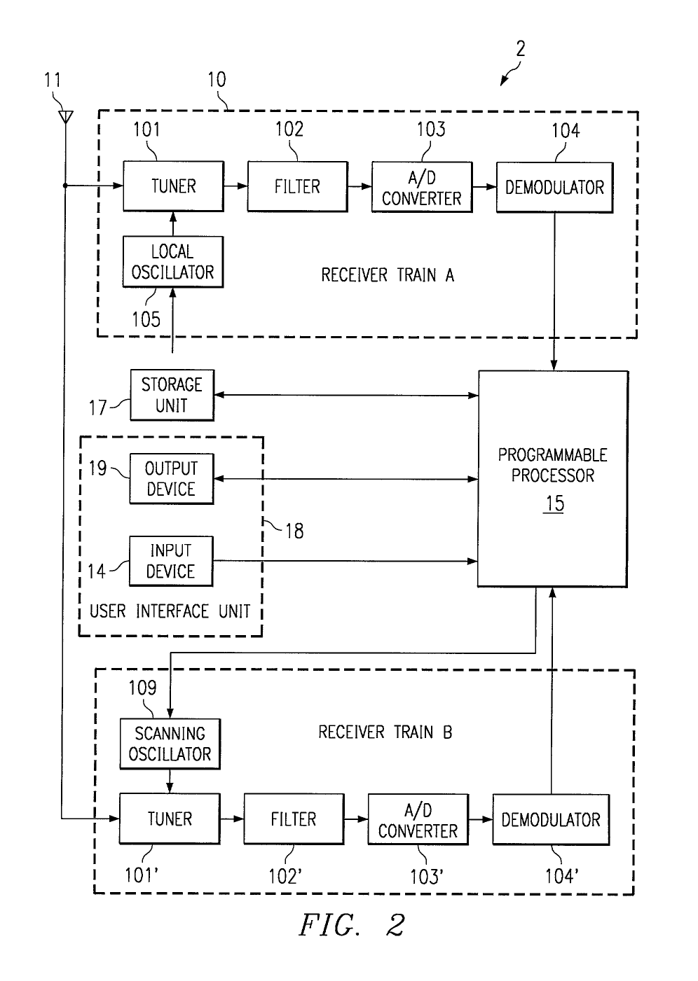

Referring to FIG. 2, a second embodiment of a digital radio receiver 2, according to the present invention, is shown. In this embodiment, the radio receiver includes two receiver trains, receiver train A 10 and receiver train B 10′, both coupled to antenna 11. Receiver train A 10, as in the embodiment of FIG. 1, includes a tuner 101, a local oscillator 105 applying a signal to the tuner 101, a filter 102, an analog to digital (A/D) converter 103, and a demodulator 105. The output signal of the demodulator 105 is applied to the programmable processor 15. Train B 10′ includes a tuner 101′ coupled to antenna 11, a scanning oscillator 109 applying a signal to the tuner 101′, a filter 102′ coupled to tuner 101′, an A/D converter 103′ coupled to the filter 102′, and a demodulator 104′ coupled to the A/D converter 103′. The output signal of the demodulator 104′ is applied to a second input terminal the programmable processor 15. The embodiment shown in FIG. 2, in addition to including a second receiver train, includes a scanning oscillator 109 in one receiver of the two receiver trains. The scanning oscillator 109 operates under control of the programmable processor 15. Thus, the radio receiver unit 2 shown in FIG. 2 can receive signals from two transmitters and can scan the broadcast spectrum with one of the receivers.

In receiver train A 10, the currently selected station is applied through programmable processor 15. The transmitter broadcasting digitally encoded signals typically broadcasts two signal streams over the same channel, a program signal and an information or data signal. For example, the program signal stream can be a frequency-modulated (FM) signal while the information signal stream can be a phase-modulated (PM) signal, the program signal stream and the information signal stream can be components in an orthogonal frequency division multiplex (OFDM) transmission, etc. The receiver train 10 can demodulate both signals and the programmable processor 15 can separate the program signals from the information signals. Typically, the program signal is applied to the user output device 19 and the information signal analyzed and/or stored or discarded. The information signal can also be applied to a display unit portion of the user interface. While the user output device 19 is typically a speaker, the user interface can include a display unit such as a liquid crystal display unit (the liquid crystal display can be interactive). In addition, the program signal or portions thereof from receiver train A 10 can be stored in the storage unit 17 in addition to being applied to the user interface 18 or as an alternative to being applied to the user interface 18. The programmable processor 15 controls the flow of demodulated signals within the radio receiver unit in accordance with the program incorporated therein and in accordance with control signals entered by the user through the input device 14.

In the receiver train B 10′, the local oscillator 101′ is adapted to be scanned in response to signals from the programmable processor 15. In general, the scanning process is similar to the seek mode in the current automotive radio. The scanning oscillator 109 responds to signals from the programmable processor 15. Within the programmable processor 15, the decision is made to halt the scanning of the broadcast band and store material from the acquired station or to continue scanning. This decision process will be discussed below, but basically, the received signals from the acquired stations are compared with preselected indicia. For example, the signal that is acquired during the scanning process can include a header indicating that the station transmitting the acquired signal provides mostly classical music (the categories can be more finely subdivided). When the category of the transmitted signal corresponds to a category to which the programmable processor is programmed to respond, the scanning will be halted while material from receiver train B 10′ is stored in the storage unit. As will be clear, the digitized signals make manipulation and processing of the signal relatively easy. However, the program material signals must reconstituted in analog form when applied to a speaker unit.

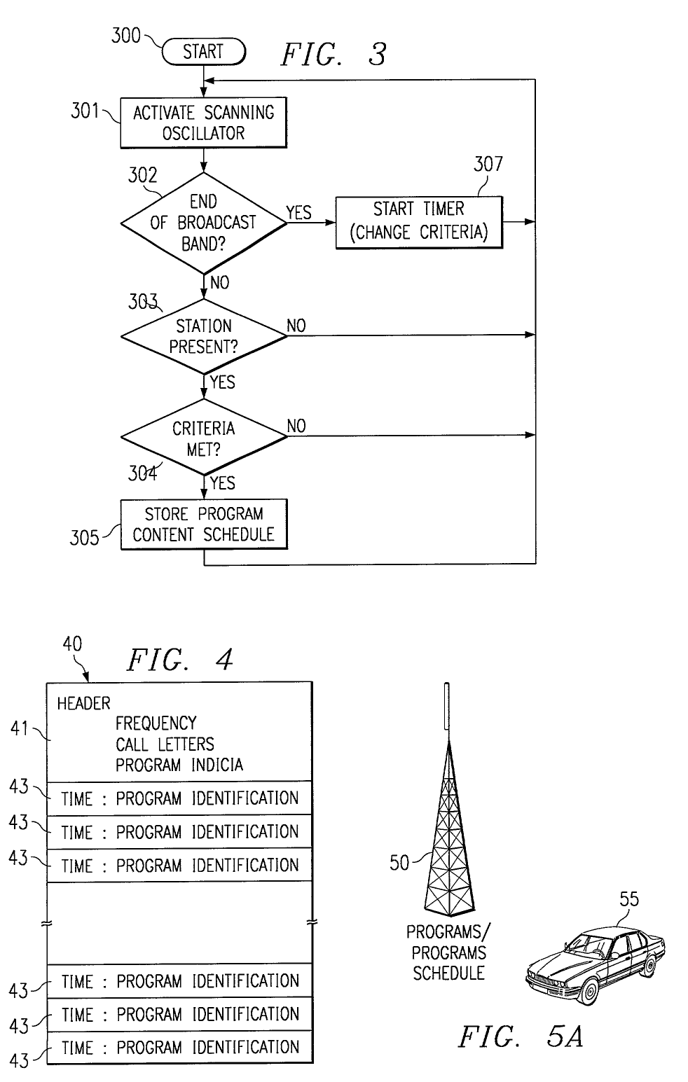

Referring to FIG. 3, the operation of the second receiver channel of a radio receiver, according to one operational embodiment of the present invention, is shown. In this operational embodiment, a schedule for all of the local transmitting stations having preselected criteria is assembled by the radio receiver 2. Each of the radio transmitters is broadcasting the upcoming schedule as at least part of the information signal stream. The operation is begun in step 300, for example, by applying power to the radio receiver unit 1. In step 301, the scanning oscillator 109′ is activated. The frequency of the activated scanning oscillator 109′ is monitored in step 302 to determine whether the end of the broadcast band has been reached. When the end of the broadcast band has not been reached, a determination is made whether a station with acceptable signal strength available at that broadcast frequency to which the scanning oscillator 109′ is tuned. If a station with acceptable signal strength is found at that broadcast frequency, then a decision is made is step 304 whether the received signal meets preselected criteria. When the preselected criteria are met in step 304, header and program schedule information are stored in the storage unit 17. After storage in the storage unit 17 in step 305, when the preselected criterion is not met in step 304, or when a station is not identified in step 303, then the activate scanning procedure is resumed in step 301. When in step 302 the determination is made that the end of the broadcast band has been reached, the start timer step 307 is entered. After the time determined by the timer has expired, the broadcast band is once again scanned. In this way, the programming schedule can be refreshed periodically. The start timer can help to implement a somewhat more sophisticated mode of operation. In this mode of operation, the broadcast frequency range is scanned, when first activated, for a central broadcast station. (The central broadcast station summarizes the programming for the local stations.) When a central station is not found, then the programming information in the information signal stream from each station must be used to acquire the type of program material and the program schedule information. Then, the criteria for storing information (i.e., in step 304) is changed so that type of program material and the program schedule information from the individual stations is stored in storage unit 17. In this situation, each local station must be accessed and the type of program material and program schedule information is stored in the storage unit for each individual broadcast station. Note that the acquisition of the program material and the program schedule in receiver train B 10′ is performed independently of receiver train A 10. The user continues to hear the program material from the station to which receiver train A 10 is tuned while receiver train B 10′ acquires information with respect to the program type and program schedule from all the stations with sufficient signal strength to be demodulated. As will be clear, the receiver chain B 10′ can continuously update the program material in the storage unit 17, thereby eliminating the need for the start timer procedure.

Referring to FIG. 4, one embodiment of the structure of files 40 stored in the storage unit 17 is illustrated as a result of the procedure in FIG. 3. The files include a header 41 and at least one program schedule file 43. The header includes the frequency of the transmitting station and the call letter station identification as well as indicia of the general program content of the station to which the program schedule files pertain. The header can be used by the processor to select files for storage in the storage unit 17 and/or to select files to be applied the user interface 18. The files 33 include at least a starting time and program identification.

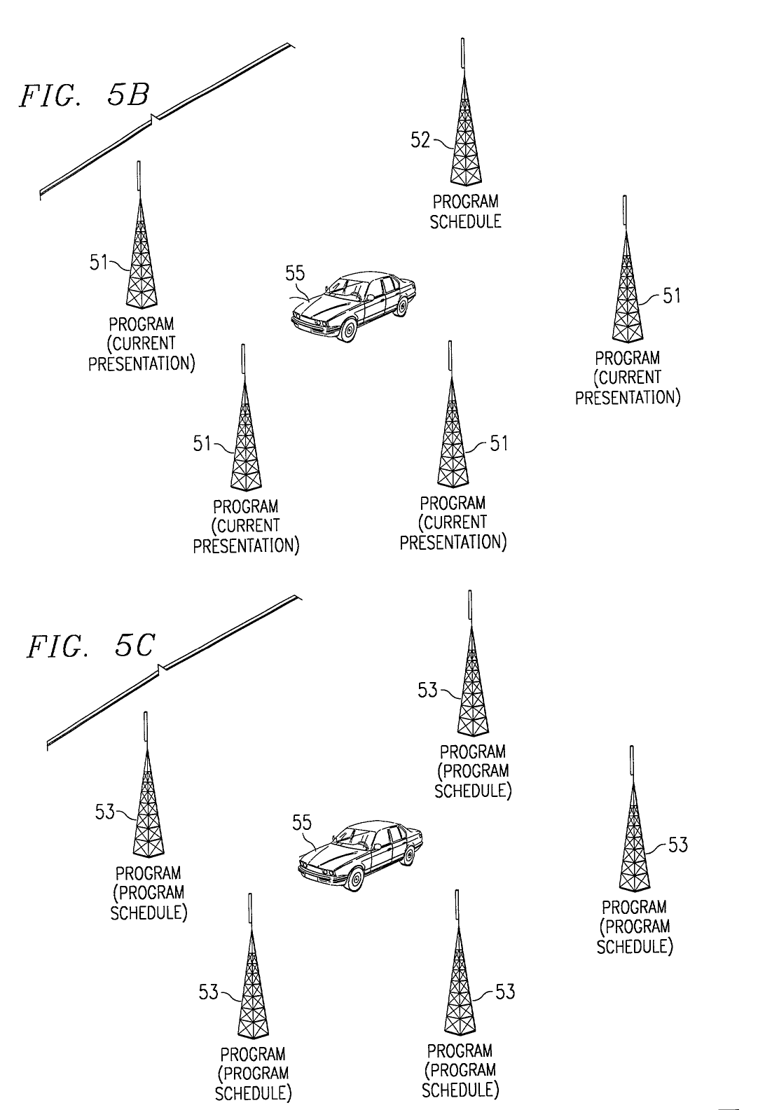

Referring to FIG. 5A, FIG. 5B, and FIG. 5C, three radio broadcast environments in which the present invention is designed to operate are shown. In FIG. 5A, a broadcast environment in which a single antenna 50 broadcasts a plurality of programs and a schedule for the plurality of programs on a single broadcast band is shown. One technique for broadcasting a plurality of programs and the schedule information is using the techniques of time division multiplexing. In time division multiplexing, a sequence of time intervals is divided into subintervals. Each specified subinterval includes a (typically compressed) portion of a preselected program. Similarly, a frequency division multiplex technique can be employed in which portions of the broadcast band frequency range transmit preselected programs. In vehicle 55, after the demodulated signal is applied to processor 15, the processor identifies the appropriate time or frequency subinterval for the broadcast band and expands the compressed data, if necessary. The restored data is applied to either the storage unit 17, to the output device 19, or both depending on the application. In the preferred embodiment, one of the subintervals is devoted to a program schedule and/or summary information for the programs contained in the subintervals. The user selects a particular subinterval to access desired program data. In FIG. 5B, the radio receiver in the automobile 55 receives signals from a plurality of transmitters 51 and from a transmitter 52. The radio transmitters 51 are devoted to providing the program content material, the type of material that is demodulated in receiver train A 10 of FIG. 1 and applied to the user interface 18. In contradistinction, the transmitter 52 provides program content material, i.e., the type of material that would be stored in the storage unit 17. In FIG. 5C, the automobile 55 receives signals from radio transmitters 53 that are of the same type. Each transmitter broadcasts one signal that provides the program material and broadcasts a second signal on the same frequency with program schedule and program characterization material. As indicated above, these signals for the station to which the receiver is currently tuned can both be demodulated in receiver train A 10 and the two signal streams separated by the programmable processor 15. While each radio transmitter could broadcast the schedule for the neighboring (and possibly) competing stations, the most likely situation is that each station will provide only its own program schedule. In this situation, the second receiver B 10′ can scan the broadcast band to assemble program schedules of stations meeting the criteria established by the user in the storage unit 17. While the program material and the program schedule material are broadcast on the same channel, the signals can be separated by the processor of the radio receiver after being demodulated by the receiver train.

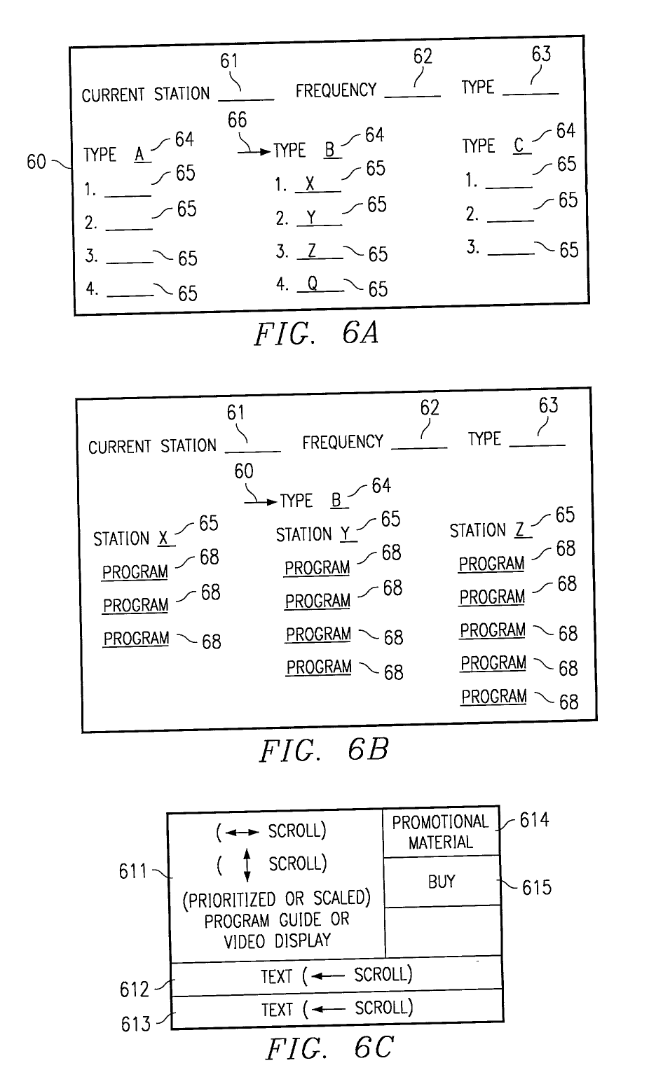

Referring to FIG. 6A and FIG. 6B, one implementation of a display for use with the digital radio of the present invention is shown. In FIG. 6A, the display includes the call letters of the current station 61 to which the digital radio receiver is tuned. Along with the call letters is the frequency 62 of the station. Also displayed on the same line is the type of program material 63 that is typically transmitted by the station. The type of material 63 identifies whether the station broadcasts predominantly news programming, talk show programming, country music programming, classical music programming, etc. Beneath the line identifying the station call letters 61, station frequency 62 and the predominant type of programming 63, is a line indicating at least one type of programming 64, three types being shown in FIG. 6A. Beneath each displayed type of programming 64 are the stations 65 that specialize in that type of programming and for which information has been demodulated in receiver train B 10′. This information has typically been assembled and stored in the storage unit 17. In addition, the display provides a marker (pointer) 66 permitting the user to select a program type for which more detailed information can be displayed. When the user, using pointer 66, selects a type of program material, for example, country western music, the display mode shown in FIG. 6B is activated. In this display mode, the top line of the display remains the same as the display mode of FIG. 6A and displays the current station 61, the frequency of the station 62, and the type of program material 63 typically broadcast by the station to which the receiver unit is currently tuned. In the next line, the selected type of program material (i.e., TYPE B) is displayed. On the next line of the display, the group of stations 65 identified as broadcasting that type of material, i.e., the same stations 65 listed under TYPE B in the display of FIG. 6A, are displayed. Beneath the station identification is listed the programs that are scheduled to be broadcast. In general, the program schedule can include the scheduled times for each program element. In this manner, a user can sort through potential subject without being exposed to irrelevant material. Referring to FIG. 6C, more complicated output device, display 610, is illustrated. According to the preferred embodiment, this display 610 includes a portion 611 of the display devoted to an expanded program guide. This information displayed by the portion 611 of display 610 can prioritized, can be scaled, and can scrolled either up and down or left and right. The particular format of the display is controlled by the program controlling the associated processor and by inputs by the user through the user input device 14. In the preferred embodiment, when a program selection has been made and the program guide is no longer required, the display portion 611 can display video material. The video material can include images text and can be accompanied by sound. The display 610 further includes portions 612 and 613. These display portions 612 and 613 are text materials that scroll across the display. Typically, this textual material can include traffic reports, local weather reports, stock market reports, sports summaries etc. Another portion 614 of the display is reserved for promotional materials. An associated buy portion 615 of the display permits the user to purchase the promotional material of display portion 614. The buy portion 615 can be accessed by a cursor and activated by a button. The buy portion 615 can also be activated by a touch technique by a probe (not shown). As will be clear, a method of indicating the acceptance to the transmitter must be provided. As will be clear, the video display 611 and/or the text displays 612 and 613 can be materials for which receipt of an acceptance is required.

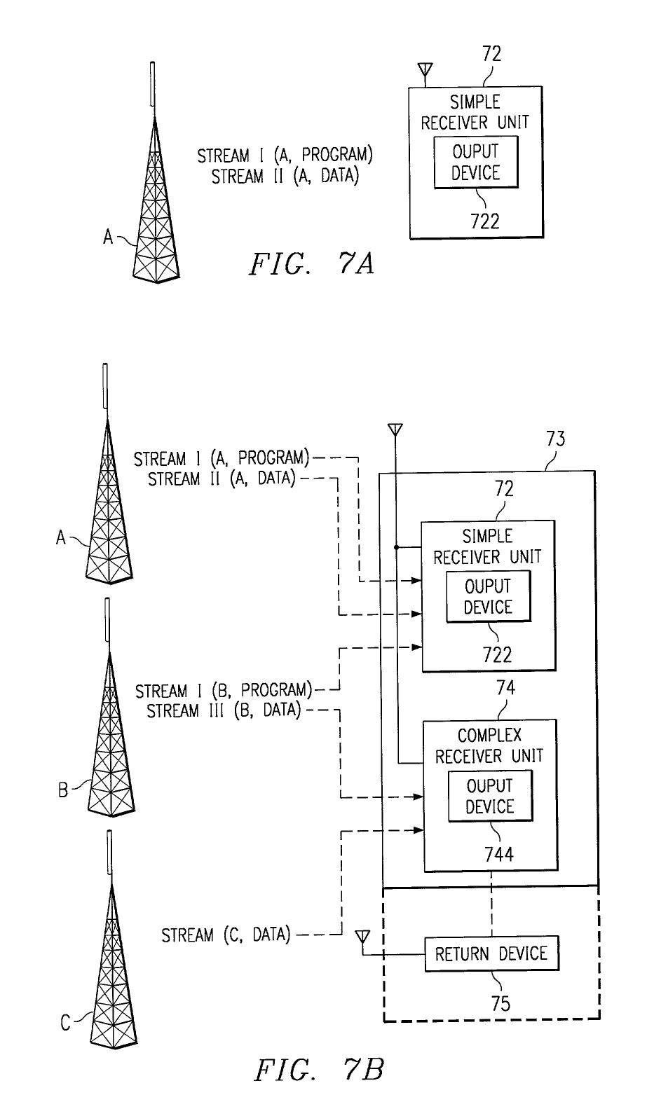

Referring to FIG. 7A, a digital radio system having a simple receiver unit 72, according to the present invention, is shown. In this system, a transmitter unit A broadcasts a signal frequency (band) that includes two signal streams, signal stream I (A) includes the program information, while signal stream II (A) includes data material such as a program guide or schedule material. The two signal streams can be obtained by multiplexing signal streams, by different types of modulation in the broadcast frequency band for the two signal streams, etc. The receiver 72 is a simple receiver as shown by receiver 1 in FIG. 1. The receiver train A 10 demodulates the signal of a selected broadcast band and the receiver train A 10 applies the demodulated signal to the processor 15. In the processor 15, the two signal streams are separated and treated as determined by the programming in processor 15. The simple receiver unit 72 includes an output device 722. The output device 722 in this system typically is relatively simple and may be a display of the type described with respect to FIG. 6A and FIG. 6B, a loudspeaker, etc. Referring to FIG. 7B, a more complex digital radio broadcast system is shown. The complex broadcast system permits allows a receiver 73 to include a complex receiver unit 74. The complex receiver unit 74 includes a more flexible and a more complex output device 744. Typically, the complex receiver unit 74 is not accessible to the driver of an automobile, the display unit being too complicated for easy interaction by the driver. In the preferred embodiment, the receiver 73 includes a simple receiver unit 72 of the type described with respect to FIG. 7A. The receiver 73 can receive signals from three types of broadcasting units. Broadcast unit A provides a signal stream I A that includes the program material and a signal stream II A that provides program-related or other data. While the complex receiver 74 can process and use these signals, the simple receive unit can also process and use these signals. Either the simple receiver unit 72 or the complex receiver unit 74 can be programmed to accept these signals. However, when both the simple receiver unit and the complex receiver unit are present, the signal streams will typically be applied to the simple receiver unit 72 as shown by the dotted lines in FIG. 7B. Broadcasting unit B provides two signal streams. Signal stream I B typically includes program information and this type of information is applied to the simple receiver unit 72 for use by the user. Signal stream III B can provide more detailed information with respect to the program signal stream and/or can provide detailed information of the type described with respect to FIG. 6C. Receiver 73, in one embodiment, includes a return device 75. This device 75 provides the user with the capability of customizing the broadcast materials being received. In addition, the customized materials can include materials for which additional compensation is required. For example, the return device 75 can be a cell phone. The return device 75 can be used to indicate the acceptance of services displayed on the output unit 744.

2. Operation of the Preferred Embodiments

Several technologies converge in present invention. The continuing reduction in cost in digital components permits these components to be placed in consumer goods, e.g., radio receivers. Similarly, the reduction in price in semiconductor along with increasing storage capacity permits the use of complex algorithms and extensive files. By way of specific example, a program element, such as a recording of a song by a particular artist can have both a catalog number identifier as well as a group of digital signals that can be applied to a speaker and identify the song orally. With the incorporation of digital apparatus, more complex storage and retrieval algorithms can be used to store and retrieve selectively many files. The programmable processor permits power and flexibility in the manipulation of data. Radio transmitters can currently provide two signals on a single channel. A single receiver can demodulate the transmission, but the processor is necessary to sort the two streams of information. The two signal streams in a single channel permit one signal stream to be the program material and the second signal stream to provide information. The provided information can be selected from a station identification, a current program identifier, program schedule information, general information such as the time, traffic conditions. Finally, the number of radio transmitting stations is steadily expanding as stations attempt to target smaller and/or more specialized niches. In an urban area, several transmitting stations may attempt to target the same segment. While this proliferation provides great flexibility to the radio receiver user, the problem has become how to take advantage of the available programming material.

The operation of the invention can be understood as follows. The preferred embodiment is a mobile radio receiver, particularly, an automobile radio. In this application of the invention, the interaction between the driver and the radio should be kept to a minimum to avoid distraction during the operation of the vehicle. In addition, the environment in the automotive application can not only be diverse, but can change depending on the distance that the vehicle travels. In an urban environment, the number of stations and the niche programming can be the predominant factors. In the rural areas, the stations are generally fewer and the program content less specialized.

In the urban environment, a central station summarizing the program content of the radio transmitters may be feasible. In this situation, receiver train that includes the scanning oscillator will scan the frequency range until some identifier in the signal indicates that the station is broadcasting program schedule material for a group of stations. The receiver train having the ability to scan the broadcast spectrum will scan the spectrum until the central station is identified. The content of signals from the central station are stored along with preselected indicia identifying the type of programming associated each station for which a program schedule is provided. The central station can provide the programming schedule for either a shortened period or for an extended period. When the programming is for a shortened period, then the storage unit can be periodically refreshed.

In a rural environment, the relatively low density of radio stations suggests that a central station would be too expensive to be feasible. In this situation, the individual stations will provide their own header and program content on the same frequency, but with characteristics that permit the separation of the two signals by the processor. This material will be transmitted at the same frequency, but modulated using different methods. For example, one of the signals may be frequency modulated and one of the signals may phase modulated. The scanning oscillator in receiver train B will scan the frequencies until a station having a signal with at least a minimum signal strength is detected. The header and the program summary material are stored. After the header and program material for one station is stored (or discarded as not being of interest), the scanning oscillator will then acquire the next station and repeat the procedure. In this manner, a programming summary of all the available stations along with preselected indicia can be stored in the storage unit.

As will be clear, these environments are not exclusive. The second receiver train can scan the entire broadcast spectrum and store signal from a central transmitter and from the local broadcast transmitters. The processor can be programmed store and access signals from both environments, but not to apply any duplicates to the speaker/output system.

The present invention can be implemented in two selectable modes. In the first mode, the preferences indicated by the user determine whether the programming associated with a header having preselected indicia are stored in the storage unit. In the second mode, the headers and associated programming for all the available stations are stored in the storage unit. When the user wishes to access the information, the selection using the preselected indicia can be done at this juncture. In either of these modes of operation, a stand-by mode of operation can be implemented. In the stand-by mode of operation, the receiver is turned off in the sense that program material is not being presented to the user, e.g., the program material is not being applied to the speaker system. However, in the stand-by mode, the broadcast spectrum continues to monitored and the various program indicia that have been programmed to be stored in the storage unit are still stored in the program unit. Thus, even though the receiver is in a sense “off”, the program indicia are being constantly or periodically up-dated. When the user “turns on” the receiver, program schedule or other information is immediately available. A waiting period for the receiver to re-acquire the station(s) and store the requisite information is thereby eliminated.

The present invention is particularly well adapted for mobile radio receivers such as are used in an automobile. The user input device can take to form of apparatus responding to oral commands. A display device will provide information in a relatively compact form for easy reference by a user.

The present invention is also suited for non-automotive applications or for more complicated secondary receivers in automotive applications, wherein the driver of the automobile does not have access to the receiver. In this situation, a relativity more complex display can be provided. For example, in the automobile application, the user can receive alternative programming material orally to minimize distractions, in the non-mobile environment, this information can be displayed on the display unit. That is, the program schedule for stations with the preselected indicia is provided visually on the display unit rather that orally over the speaker. As will be clear, this choice of presentation modes can selected by the user. In either the automotive or non-automotive application, the alternative programming material can be selected by the user. In addition to program-related information, the alternative programming content can be traffic information, news, stock market quotations, or internet access.

The ability to broadcast two signals over a single channel can provide increased flexibility. In addition to providing information of general interest, the second signal stream can be used to provide a program schedule for not only the station broadcasting the signal, but for neighboring stations as well. In this manner, the requirement for a second receiver train can be eliminated.

The processor provides great flexibility analyzing data that has been detected by the radio receiver. The user can program the processor to identify a certain program item, for example, any composition by Mozart. The processor can then alert the user to the presence of this composition and can be programmed to apply the program component to the speaker automatically. In this situation, considerable standardization must take place so that a composition by Mozart or even a particular composition by Mozart must have an identifier associated therewith that can be recognized by the program of the processor. None-the-less, once such cataloging has been performed, then the prioritization by the user can be accomplished. Furthermore, the processor can be programmed such that program material having assigned priority can be applied to the speaker automatically, i.e., without intervention of the user. In addition to the identifier associated with each program element, the oral recitation of the program element can be performed, the composition identification signal group being associated with signal group resulting in the oral identification of the composition. Such a composition identification would be particularly desirable for the automobile radio.

While in the preferred embodiment the transmitter has been described as broadcasting two signal streams in the broadcast frequency band, the invention can also be applied to signal streams that have only one signal stream. Because of the digital encoding of the signals at the transmitter, transmitted material can be compressed and several signal streams can be transmitted. For example, the signal stream can have a plurality of signals being transmitted in a multiplexed mode. In the multiplexed mode, each of a plurality of signals is assigned a time or frequency slot in the transmitted signal. The processor of the radio receiver permits the desired signal stream to be extracted from the transmitted (multiplexed) signal stream. The extracted signal can be expanded (I.e., decompressed) so that the original signal can be provided to the user interface.

Similarly, certain types of information that may be of particular significance can be identified and brought to the attention of a user. For example, traffic reports can be provided with an identifier that indicates a priority item is being broadcast. The processor can automatically store this information and, depending on the programming, can be applied immediately to the speaker.

Although not explicitly shown in FIG. 1 and FIG. 2, the processor can control the tuner 101 by controlling the local oscillator. In this manner, in the configuration shown in FIG. 1, the processor can acquire the signal stream transmitted by a broadcast station. The processor can then determine if preselected indicia are present, e.g. in the information signal stream. When the indicia are present, then the processor can apply the program signal to the user interface. When the indicia are not present, the processor can change the frequency of the local oscillator and acquire a different station. The indicia from the acquired signal stream are then compared with preselected indicia stored in the storage unit and the process is repeated.

The presence, in the present invention, of two receiver trains can be used to provide a visual (video or text) display, demodulated in one of the receiver trains, and an independent audio output, demodulated in the second receiver train. The present invention can include location/orientation apparatus based on the global positioning system (GPS) or on triangulation of the radio signals. Not only would this function be useful for location, but this function could be used in conjunction with traffic and weather alerts.

The present invention can include commercial applications such as purchasing items presented in a visual format or purchasing a specific song. The completion of the purchase can be implemented via a Bluetooth link to the user's cellular telephone, a built-in cellular telephone in the digital receiver unit (e.g., the “OnStar” system) or a removable card that can removed from the digital receiver unit and entered in an internet-coupled device. The ability by the processor to identify indicia permits a user to search for and store specific, preselected program components, such as songs, new items, etc..

It will be clear that the indicia that are recognizable by the processor can be included in a header of program material signal stream in addition to or rather than being present in a second signal stream.

Referring to FIG. 7B, the user is provided with a return path to the transmitter. The return path may be electronic apparatus integral to the radio receiver or can be an independent transmission path such as a cell phone. A return path permits the user to accept commercial offerings broadcast by the transmitter. However, the return path provides the opportunity for more complex transactions between the user and the transmitting entity. For example, when the processor is provided with decryption capability, the transmitting entity can broadcast the availability of proprietary materials in an unencrypted format while simultaneously broadcasting the encrypted program. The user can then respond to an unencrypted message and request the proprietary materials through the return path. The transmitting entity can then provide the user with the decryption key. After entering the decryption key, the processor can then decrypt the encoded program material and make the decoded material available to the user.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A digital radio receiver, the digital radio receiver comprising:
a first receiver train, the first receiver train including:
an antenna:
a tuner coupled to the antenna for selecting a broadcast frequency;
an analog-to-digital converter coupled to the tuner;
a demodulator coupled to the analog-to-digital converter;
a storage unit;
a interface unit; and
a processor coupled to the demodulator, the processor separating two signal streams transmitted at the broadcast frequency, the first signal stream including program components, the second signal stream including indicia of the program components of the first signal stream.

2. The digital radio receiver as recited in claim 1 wherein the processor uses the program indicia in the second signal stream to process the first signal stream.

3. The digital radio receiver as recited in claim 1 wherein the tuner is a wideband tuner for receiving signals from all stations in the broadcast band.

4. The digital radio receiver as recited in claim 3 wherein signal streams for multiple stations can be decoded to identify and process indicia related to program components or other information

5. The digital radio receiver as recited in claim 1 wherein the program indicia identifies categories of program components in the first signal stream.

6. The digital radio receiver as recited in claim 1 wherein the program indicia of the second signal stream identifies program components in the first signal stream.

7. The digital radio receiver as recited in claim 1 wherein the program indicia of the second signal stream identifies a schedule for all program components in the receiver area

8. The digital radio receiver as recited in claim 1 wherein the program indicia of the second signal stream identifies a schedule of program components in the first signal stream.

9. The digital radio receiver as recited in claim 1 wherein the second signal stream includes information selected from the group consisting of time information, traffic information, promotional information, and information related to items for sale.

10. The digital radio receiver as recited in claim 1 wherein the processor is programmable

11. The digital radio receiver as recited in claim 1 wherein the processor is hardwired.

12. The digital radio receiver of claim 1 wherein the radio receiver includes a stand-by mode of operation, the standby mode operation storing and up-dating program indicia in the storage unit when program components are not being processed.

13. The digital radio receiver as recited in claim 1, the radio receiver further comprising:
a second receiver train: the second receiver train including:
a scannable tuner coupled to the antenna for selecting a second broadcast frequency, the frequency of the scannable tuner determined by the processor;
a second analog-to-digital converter coupled to the tuner; and
a second demodulator coupled to the second analog-to-digital converter, the output signal of the second demodulator being applied to the processor, the processor separating the second frequency signal into a new first signal stream and a new second signal stream, wherein the new first signal stream includes program components, the new second signal stream including indicia of the new first signal program components.

14. The digital radio receiver as recited in claim 13 wherein the digital radio receiver includes a stand-by mode, wherein in the stand-by mode the first receiver train is inactivated and the second receiver train continues to store and update information program indicia in the storage unit.

15. The digital radio receiver as recited in claim 13 wherein the program indicia of the second signal stream identifies a schedule for all program components in the digital radio receiver area.

16. The digital radio receiver as recited in claim 13 wherein the second signal stream includes information selected from the group consisting of time information, traffic information, promotional information, and information related to items for sale

17. The digital radio receiver as recited in claim 13 wherein the processor is programmable.

18. The digital radio receiver as recited in claim 13 wherein the processor is hardwired.

19. The digital radio receiver as recited in claim 13 wherein the processor causes the second receiver to scan the broadcast frequencies available to the digital radio receiver, the processor using the new second signal stream to generate a schedule of program components of the available first signal streams.

20. The digital radio receiver as recited in claim 13 wherein the processor uses the indicia of the second signal stream and the new signal stream to determine the next program component to be applied to the interface unit.

21. The digital radio receiver as recited in claim 20 wherein the interface unit includes at least one of a speaker and a display unit.

22. The digital radio receiver as recited in claim 13 wherein the second receiver is tuned to a selected station, the second station transmitting a signal stream providing a schedule for program components for a plurality of stations.

23. The digital radio receiver of claim 13 wherein the radio receiver includes a stand-by mode of operation, the second receiver train in the standby mode operation storing and up-dating program indicia in the storage unit when program components are not being processed by the first receiver train.

24. A method for providing programming information to a user of digital radio receiver; wherein the radio receiver unit includes a receiver train, a user interface, a processor, an input device, and a storage unit: the method comprising:
in the receiver train, demodulating a signal from a transmitter, the signal having two signal streams; and
in the processor, separating the first signal stream from the second signal stream, wherein the first signal stream includes program components, the second signal stream having indicia related to the program components of the first signal stream.

25. The method as recited in claim 24 wherein, when the indicia of the second signal stream meet preselected criteria, applying the first signal stream to the user interface.

26. The method as recited in claim 24 wherein the indicia of the second signal stream identify the program components of the first signal stream.

27. The method as recited in claim 24 wherein the indicia of the second signal stream identify characteristics of the program components of the first signal stream.

28. The method as recited in claim 24 wherein the second signal stream includes information related to at least one of time, traffic conditions, promotional information, and information related to items for sale.

29. The method as recited in claim 24 wherein, in a stand-by mode of operation, storing and up-dating the second signal stream indicia in a storage unit when the first signal stream is not being processed.

30. The method as recited in claim 24 wherein the digital radio receiver further includes a second receiver train, the second receiver train having a scannable tuner operating under control of the processor, and a demodulator, the demodulator applying second transmitter signals to the processor, the method further comprising:
in the processor, separating the signals from the second transmitter into a new first signal stream and a new second signal.

31. The method as recited in claim 30 further comprising using the indicia of the new second signal stream to determine the signal stream to determine the signal stream applied to the interface unit.

32. The method as recited in claim 30 further comprising;
scanning the broadcast spectrum with the second receiver train;
generating a program schedule; and
storing the schedule in the storage unit.

33. The method as recited in claim 32 wherein the program schedule has program components with predetermined criteria.

34. The method as recited in claim 30 further comprising;
scanning the broadcast spectrum with the second receiver train; and
when the indicia in the new second signal steam meet preselected criteria, applying the new first signal stream to the interface unit.

35. The method as recited in claim 30 wherein, in a stand-by mode of operation, storing and up-dating program indicia processed by the second receiver unit in the memory unit when the are program components are not being processed.

36. A broadcast system comprising:
at least one transmitter unit, the transmitter unit broadcasting two signal streams in over a given frequency band:
a receiver unit, the receiver unit including:
an antenna;
a receiver train coupled to the antenna, the receiver train being tuned to the given frequency band, the receiver unit demodulating the two signal streams;
a storage unit; and
a processor, the processor separating the two signal streams into a program signal stream and an information signal stream, the information stream including information concerning the program signal stream.

37. The broadcast system as recited in claim 36 wherein the information signal stream includes a schedule for the program signal stream, the receiver unit further including a storage unit, the schedule of the program signal stream being stored in the storage unit.

38. The broadcast system as recited in claim 36 wherein the processor controls the frequency band to which the receiver train is tuned, the processor changing the frequency band to which the receiver train is tuned when the processor does not identify preselected indicia in the information signal stream.

39. The broadcast system as recited in claim 38 wherein the preselected indicia identify program components in the program signal stream.

40. The broadcast system as recited in claim 39 wherein the preselected indicia identify a class of program components.

41. The broadcast system as recited in claim 36 wherein the receiver unit has a stand-by mode, portions of the second signal stream being stored and up-dated in the storage unit when the program components are not being presented to the user.

42. The broadcast system as recited in claim 36 wherein the receiver unit includes:
a second receiver train, the second receiver train including a scannable tuner, the scannable tuner controlled by the processor; wherein the processor identifies indicia in the second frequency band.

43. The broadcast system as recited in claim 42 wherein the indicia in the second frequency band form a portion of a schedule of program components for the second frequency band.

44. The broadcast system as recited in claim 43 wherein the indicia in the second frequency band cause the tuner in the receiver train to be tuned to the second frequency band.

45. The broadcast system as recited in claim 43 wherein the receiver unit has a stand-by mode, indicia from the second receiver unit being stored and up-dated in the storage unit in the stand-by mode when program components are not being presented to the user.

46. In a digital radio receiver, a user interface, the user interface comprising a output device for displaying information, the information including at least one display selected from a group consisting of a list of broadcast stations matching predetermined user preferences, promotional advertising, scrolling text information, a scrolling program guide, a video display, and internet access.

47. The user interface as recited in claim 46 wherein the radio receiver receives signals from a broadcast transmitter; the radio receiver further including apparatus permitting a return path to the broadcast transmitter; the return path permitting a user of the digital receiver to respond to the information displayed on the user interface; the apparatus implementing the return path selected from the group consisting of a cellular phone, a Bluetooth to cellular link, a satellite link, and a microwave link: the return path permitting the user to engage in an activity selected from the group consisting of accessing the internet and the purchase of products.

48. The user interface as recited in claim 46 further comprising an input device, the input device selected from the group consisting of touch screen, manually-activated knobs, voice response system, and a keyboard.

49. The user interface as recited in claim 46 wherein the digital radio receiver has a processor coupled to the interface unit and a storage unit, the user interface permitting the user to apply a first signal stream to the output device, the user interface permitting the user to apply a second signal stream to the storage unit.

50. A digital radio system including at least one transmitter and at least one receiver, the transmitter broadcasting signals comprising at least one format selected from the group of formats consisting of; a program component signal stream and a program guide signal stream, a program guide signal stream and at least one business signal stream, and at least one program content signal stream, a program guide signal stream and at least one business signal stream.

51. The digital radio system as recited in claim 50 wherein a business signal stream can include promotional material or items offered for sale.

52. The digital radio system as recited in claim 50 wherein the signal streams are formed by time division multiplexing the broadcast signal stream.

53. The digital radio system as recited in 50 wherein the signal streams are implemented by a frequency division multiplexing the broadcast signal stream.
